(19) United States
(12) Patent Application Publication
(10) Pub. No.: US 2022/0033736 A1
(43) Pub. Date: Feb. 3, 2022

(54) DETERGENT COMPOSITION

(71) Applicant: Conopco, Inc., d/b/a UNILEVER, Englewood Cliffs, NJ (US)

(72) Inventors: Stephen Norman BATCHELOR, Chester (GB); Neil Stephen BURNHAM, Liverpool (GB); Andrew Thomas COOK, Liverpool (GB); Dietmar Andreas LANG, Liverpool (GB)

(73) Assignee: Conopco, Inc., d/b/a UNILEVER, Englewood Giiffs, NJ (US)

(21) Appl. No.: 17/275,934

(22) PCT Filed: Sep. 12, 2019
(86) PCT No.: PCT/EP2019/074425

§ 371 Date: Mar. 12, 2021

(30) Foreign Application Priority Data
Sep. 18, 2018 (EP) 18195305.0

(51) Int. Cl. C11D 3/20; C11D 3/386; C11D 1/72; C11D 1/06; C11D 1/29; C11D 1/831; C11D 11/00; C11D 17/00; C11D 17/04

(52) U.S. Cl. CPC C11D 3/2093; C11D 3/38636; C11D 3/38618; C11D 1/72; C11D 17/042; C11D 1/29; C11D 1/831; C11D 11/0017; C11D 17/0008; C11D 1/06

(57) ABSTRACT

The present invention concerns a detergent composition, comprising: a) from 2 to 95 wt. %, preferably from 2 to 50 wt. %, more preferably from 2 to 40 wt. %, most preferably from 2.5 to 40 wt. % of an organic acid derivative of mono- and di-glycerides of the form:—(I) wherein one or two, of R₁, R₂ and R₃ are independently selected from an acyl group of the formula R₄CO—; where R₄ is a linear or branched, saturated or mon-unsaturated C₉ to C₂₁ alkyl chain; wherein one or two, of R₁, R₂ and R₃ is selected from an organic acid of generic formulation (HOOC)ₙXCO—; wherein X is saturated or monounsaturated organic group containing 1 to 6 carbon atoms and n=1 to 3; wherein one or none of R₁, R₂ and R₃ is enzyme; and to domestic method of treatment of a textile using said composition.

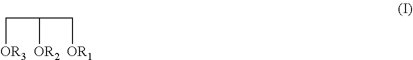

### FIELD OF INVENTION

The present invention concerns a detergent composition. More particularly a detergent composition comprising a surfactant which is an organic acid derivative of mono- and di-glycerides, and lipase (lipid esterase).

### BACKGROUND OF THE INVENTION

Organic acid ester derivatives of mono- and di-glycerides are surfactants used in food processing, for example in bakery to improve bread quality or in chocolate to prevent blooming. They are produced from animal and plant based ingredients.

Detergents typically include a lipase to hydrolyse fats. Surfactants are used in detergents to solubilise fats. However, it is found that conventional surfactants can adversely affect lipase.

It is desirable to find surfactants that do not have this adverse effect on the lipase, and so show improved lipase performance.

### SUMMARY OF THE INVENTION

The invention relates in a first aspect to a detergent composition comprising:
a) from 2 to 95 wt. %, preferably from 2 to 50 wt. %, more preferably from 2 to 40 wt. %, most preferably from 2.5 to 40 wt. % of an organic acid derivative of mono- and di-glycerides of the form:—

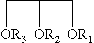

wherein one or two, preferably one, of R₁, R₂ and R₃ are independently selected from an acyl group of the formula R₄CO— where R₄ is a linear or branched, saturated or mon-unsaturated C₉ to C₂₁ alkyl chain, preferably C₁₅ to C₂₁ linear alkyl chain, most preferably a saturated or mon-unsaturated C₁₅ to C₁₇ linear alkyl chain;
wherein one or two, preferably one, of R₁, R₂ and R₃ is selected from an organic acid of generic formulation (HOOC)ₙXCO— where in X is saturated or monounsaturated organic group containing 1 to 6 carbon atoms and n=1 to 3;
wherein one or none of R₁, R₂ and R₃ is selected from H, preferably one of R₁, R₂ and R₃ is selected from H; and,
b) from 0.0005 to 0.5 wt. %, preferably from 0.005 to 0.2 wt. % of a lipid esterase enzyme.

In a second aspect the present invention provides a domestic method of treating a textile, the method comprising the steps of:—
a) treating a textile with an aqueous solution of 0.5 to 20 g/L, more preferably 1 to 10 g/L of the detergent composition according to the first aspect of the invention;
b) optionally rinsing and drying the textile.

Preferably wherein (HOOC)ₙXCO is selected from citric acid, malic acid, tartaric acid, monoacetyl and diacetyl tartaric acid, succinic acid, oxalic acid, maleic acid, fumaric acid, malonic acid, more preferably citric acid, lactic acid, tartaric acid, monoacetyl and diacetyl tartaric acid, where an OH is lost from an acid group to form the ester.

Preferably the organic acid derivative of mono- and di-glycerides are selected from:—citric acid esters of mono- and diglycerides (citrem); tartaric acid esters of mono- and di-glycerides (tatem); diacetyltartaric acid esters of mono- and diglycerides (datem); and mixed acetic-, tartaric- and di-acetylated tartaric acid esters of mono- and di-glycerides (MATEM); preferably the organic acid derivative of mono- and di-glycerides are selected from:—citric acid esters of mono- and diglycerides (citrem).

Preferably the detergent composition is a laundry detergent composition.

Preferably the laundry detergent composition comprises an anionic surfactant selected from C₁₂ to C₁₈ alkyl ether carboxylate and water-soluble alkali metal salts of organic sulphates, ether sulphates and sulphonates having alkyl radicals containing from about 8 to about 22 carbon atoms.

Preferably the lipid esterase is selected from triacylglycerol lipases (E.C. 3.1.1.3); carboxylic ester hydrolase (E.C. 3.1.1.1); Cutinase (E.C. 3.1.1.74); sterol esterase (E.C. 3.1.1.13); wax-ester hydrolase (E.C. 3.1.1.50), preferably a triacyglycerol lipases (E.C. 3.1.1.3).

Preferably the laundry detergent composition comprises one or more enzymes from the group: proteases, amylases and cellulases.

Preferably the composition is a liquid or a liquid unit dose composition.

### DETAILED DESCRIPTION OF THE INVENTION

The formulation may be in any form for example a liquid, solid, powder, liquid unit dose.

Preferably the composition is a liquid or a liquid unit dose composition.

The formulation when dissolved in demineralised water preferably has a pH of 4 to 8, more preferably 6.5 to 7.5, most preferably 7.

Organic Acid Derivative of Mono and Diglycerides

In the text, organic acid derivative of mono- and di-glycerides will be referred to as glyceride carboxylates.

The organic acid derivative of mono- and di-glycerides are of the form:—

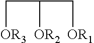

wherein one or two, preferably one, of R₁, R₂ and R₃ are independently selected from an acyl group of the formula R₄CO— where R₄ is a linear or branched, saturated or mon-unsaturated C₉ to C₂₁ alkyl chain, preferably C₁₅ to C₂₁ linear alkyl chain, most preferably a saturated or mon-unsaturated C₁₅ to C₁₇ linear alkyl chain;

wherein one or two, preferably one, of R₁, R₂ and R₃ is selected from an organic acid of generic formulation (HOOC)ₙXCO— where in X is saturated or monounsaturated organic group containing 1 to 6 carbon atoms and n=1 to 3;

wherein one or none of R₁, R₂ and R₃ is selected from H, preferably one of R₁, R₂ and R₃ is selected from H.

Preferably (HOOC)ₙXCO is selected from citric acid, malic acid, tartaric acid, monoacetyl and diacetyl tartaric acid, succinic acid, oxalic acid, maleic acid, fumaric acid, malonic acid, more preferably citric acid, lactic acid, tartaric acid, monoacetyl and diacetyl tartaric acid, where an OH is lost from an acid group to form the ester.

Weights of the organic acid derivative of mono- and di-glycerides are for the protonated form.

Glyceride carboxylate may be synthesised by the esterification of mono and diglycerides with organic acids. Mono and diglycerides may be produced by fat glycerolysis (200° C., Basic catalyst). The monoglycerides may be separated by distillation under high vacuum. Mono and diglycerides may also be produced by lipid esterase catalysed hydrolysis of the fat. The organic acid is may then added by an esterification reaction, or reaction with the anhydride of the organic acid where the structure permits.

The properties and synthesis of glyceride carboxylates are discussed in Hasenhuetti, G. L and Hartel, R.W. (Eds) Food Emulsiflers and Their Application. 2008 (Springer) and in Whitehurst, R.J. (Ed) Emulsiflers in Food Technology 2008 (Wiley-VCH) and in the 2^{nd} edition of this book edited by V. Norn 2015 (Wiley-Blackwell).

Preferred organic acid derivative of mono- and di-glycerides are selected from:—

E472c Citric acid esters of mono- and diglycerides (citrem);

E472d Tartaric acid esters of mono- and diglycerides (tatem);

E472e Diacetyltartaric acid esters of mono- and diglycerides (datem); and,

E472f Mixed acetic-, tartaric- and diacetylated tartaric acid esters of mono- and diglycerides (MATEM).

More preferred organic acid derivative of mono- and di-glycerides are selected from:—

E472c Citric acid esters of mono- and diglycerides (citrem);

E472d Tartaric acid esters of mono- and diglycerides (tatem); and,

E472e Diacetyltartaric acid esters of mono- and diglycerides (datem).

Where is the E number is the codes for substances that are permitted to be used as food additives for use within the European Union.

E472c Citric acid esters of mono- and diglycerides (citrem) is most preferred.

Preferably the glyceride carboxylate is an acid ester of a mono glyceride. Preferably the mono glyceride is obtained from plants, preferably from rape seed, sunflower, maze, soy, peanut, cottonseed, olive oil, tall oil.

The glyceride carboxylate may be in salt form or acid form, typically in the form of a water-soluble sodium, potassium, ammonium, magnesium or mono-, di- or tri-C₂-C₃ alkanolammonium salt, with the sodium cation being the usual one chosen.

Preferably the glyceride carboxylate has predominately saturate and mono-unsaturated C₁₈ linear alkyl chains, most preferably the weight fraction of (C₁₈ glyceride carboxylate)/(C₁₆ glyceride carboxylate) is preferably from 2 to 400, more preferably 8 to 200 where the weight of glyceride carboxylate is for the protonated form.

Examples of preferred structures are

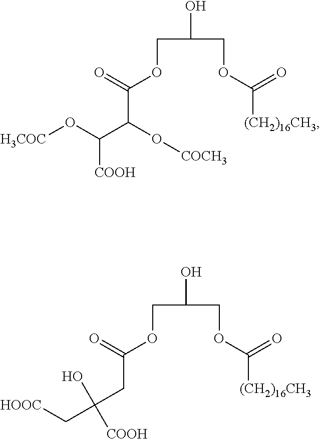

These are saturated C₁₈ glyceride carboxylates.

Preferably the glyceride carboxylates contain less than 1 wt. % of material with polyunsaturated alkyl chains, more preferably less than 0.5 wt. %, most preferably less than 0.1 wt. %. This may be achieved by hydrogenation of the oil.

Glyceride carboxylates are available from Danisco, Palsgaard, and Acatris.

The organic acid derivative of mono- and di-glycerides is present at a level of from 1 to 95 wt. %, preferably from 1.5 to 50 wt. %, more preferably from 2 to 40 wt. %. Other preferred levels include 2.5 wt. % to 95 wt. % preferably from 2.5 to 50 wt. %, more preferably from 2.5 to 40 wt. %. Other preferred levels include 3 wt. % to 95 wt. % preferably from 3 to 50 wt. %, more preferably from 3 to 40 wt. %.

Glyceride carboxylate are often supplied with unsubstituted mono and diglycerides, preferably the weight ratio of (glyceride carboxylate/(unsubstituted mono and diglycerides) is greater than 1, more preferably greater than 2, most preferably greater than 4. Preferably the unsubstituted mono and diglycerides are predominately monoglycerides by weight.

Lipid Esterase

Cleaning lipid esterases are discussed in Enzymes in Detergency edited by Jan H. Van Ee, Onno Misset and Erik J. Baas (1997 Marcel Dekker, New York).

Cleaning lipid esterases are preferable active at alkaline pH in the range 7 to 11, most preferably they have maximum activity in the pH range 8 to 10.5.

The lipid esterase may be selected from lipase enzymes in E.C. class 3.1 or 3.2 or a combination thereof.

Preferably the cleaning lipid esterases is selected from:

(1) Triacylglycerol lipases (E.C. 3.1.1.3)

(2) Carboxylic ester hydrolase (E.C. 3.1.1.1)

(3) Cutinase (E.C. 3.1.1.74)

(4) Sterol esterase (E.C. 3.1.1.13)

(5) Wax-ester hydrolase (E.C. 3.1.1.50)

Triacylglycerol lipases (E.C. 3.1.1.3) are most preferred.

Suitable triacylglycerol lipases can be selected from variants of the Humicola lanuginosa (Thermomyces lanuginosus) lipase. Other suitable triacylglycerol lipases can be selected from variants of Pseudomonas lipases, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), Bacillus lipases, e.g., from B. subtilis (Dartois et al. (1993), Biochemica et Biophysica Acta, 1131, 253-360), B. stearothermophilus (JP 64/744992) or B. pumilus (WO 91/16422).

Suitable carboxylic ester hydrolases can be selected from wild-types or variants of carboxylic ester hydrolases endogenous to B. gladioli, P. fluorescens, P. putida, B. acidocaldarius, B. subtilis, B. stearothermophilus, Streptomyces chrysomallus, S. diastatochromogenes and Saccaromyces cerevisiae.

Suitable cutinases can be selected from wild-types or variants of cutinases endogenous to strains of Aspergillus, in particular Aspergillus oryzae, a strain of Altemaria, in particular Altemaria brassiciola, a strain of Fusarium, in particular Fusarium solani, Fusarium solani pisi, Fusarium oxysporum, Fusarium oxysporum cepa, Fusarium roseum culmorum, or Fusarium roseum sambucium, a strain of Helminthosporum, in particular Helminthosporum sativum, a strain of Humicola, in particular Humicola insolens, a strain of Pseudomonas, in particular Pseudomonas mendocina, or Pseudomonas putida, a strain of Rhizoctonia, in particular Rhizoctonia solani, a strain of Streptomyces, in particular Streptomyces scabies, a strain of Coprinopsis, in particular Coprinopsis cinerea, a strain of Thermobifida, in particular Thermobifida fusca, a strain of Magnaporthe, in particular Magnaporthe grisea, or a strain of Ulocladium, in particular Ulocladium consortiale.

In a preferred embodiment, the cutinase is selected from variants of the Pseudomonas mendocina cutinase described in WO 2003/076580 (Genencor), such as the variant with three substitutions at 1178M, F180V, and S205G.

In another preferred embodiment, the cutinase is a wild-type or variant of the six cutinases endogenous to Coprinopsis cinerea described in H. Kontkanen et al, App. Environ. Microbiology, 2009, p 2148-2157

In another preferred embodiment, the cutinase is a wild-type or variant of the two cutinases endogenous to Trichoderma reesei described in WO2009007510 (VTT).

In a most preferred embodiment the cutinase is derived from a strain of Humicola insolens, in particular the strain Humicola insolens DSM 1800. Humicola insolens cutinase is described in WO 96/13580 which is hereby incorporated by reference. The cutinase may be a variant, such as one of the variants disclosed in WO 00/34450 and WO 01/92502. Preferred cutinase variants include variants listed in Example 2 of WO 01/92502. Preferred commercial cutinases include Novozym 51032 (available from Novozymes, Bagsvaerd, Denmark).

Suitable sterol esterases may be derived from a strain of Ophiostoma, for example Ophiostoma piceae, a strain of Pseudomonas, for example Pseudomonas aeruginosa, or a strain of Melanocarpus, for example Melanocarpus albomyces.

In a most preferred embodiment the sterol esterase is the Melanocarpus albomyces sterol esterase described in H. Kontkanen et al, Enzyme Microb Technol., 39, (2006), 265-273.

Suitable wax-ester hydrolases may be derived from Simmondsia chinensis.

The lipid esterase is preferably selected from lipase enzyme in E.C. class 3.1.1.1 or 3.1.1.3 or a combination thereof, most preferably E.C.3.1.1.3.

Examples of EC 3.1.1.3 lipases include those described in WIPO publications WO 00/60063, WO 99/42566, WO 02/062973, WO 97/04078, WO 97/04079 and U.S. Pat. No. 5,869,438. Preferred lipases are produced by Absidia reflexa, Absidia corymbefera, Rhizmucor miehei, Rhizopus deleman Aspergillus niger, Aspergillus tubigensis, Fusarum oxysporum, Fusarium heterosporum, Aspergillus oryzea, Penicilium camembertii, Aspergillus foetidus, Aspergillus niger, Thermomyces lanoginosus (synonym: Humicola lanuginosa) and Landerina penisapora, particularly Thermomyces lanoginosus. Certain preferred lipases are supplied by Novozymes under the tradenames. Lipolase®, Lipolase Ultra®, Lipoprime®, Lipoclean® and Lipex® (registered tradenames of Novozymes) and LIPASE P “AMANO®” available from Areario Pharmaceutical Co. Ltd., Nagoya, Japan, AMANO-CES®, commercially available from Toyo Jozo Co., Tagata, Japan; and further Chromobacter viscosum lipases from Amersham Pharmacia Biotech., Piscataway, N.J., U.S.A. and Diosynth Co., Netherlands, and other lipases such as Pseudomonas gladioli. Additional useful lipases are described in WIPO publications WO 02062973, WO 2004/101759, WO 2004/101760 and WO 2004/101763. In one embodiment, suitable lipases include the “first cycle lipases” described in WO 00/60063 and U.S. Pat. No. 6,939,702 BI, preferably a variant of SEQ ID No. 2, more preferably a variant of SEQ ID No. 2 having at least 90% homology to SEQ ID No. 2 comprising a substitution of an electrically neutral or negatively charged amino acid with R or K at any of positions 3, 224, 229, 231 and 233, with a most preferred variant comprising T23 IR and N233R mutations, such most preferred variant being sold under the tradename Lipex® (Novozymes).

The aforementioned lipases can be used in combination (any mixture of lipases can be used). Suitable lipases can be purchased from Novozymes, Bagsvaerd, Denmark; Areario Pharmaceutical Co. Ltd., Nagoya, Japan; Toyo Jozo Co., Tagata, Japan; Amersham Pharmacia Biotech., Piscataway, N.J., U.S.A.; Diosynth Co., Oss, Netherlands and/or made in accordance with the examples contained herein.

Lipid esterase with reduced potential for odor generation and a good relative performance, are particularly preferred, as described in WO 2007/087243. These include Lipoclean® (Novozyme).

Further Ingredients

The formulation may contain further ingredients.

Further Surfactant

Surfactants are discussed in the Surfactant Science Series published by CRC press, series editor. Arthur T. Hubbard.

Further surfactant may be present at a preferable level of from 0.5 to 40 wt. %, more preferably from 1 to 30 wt. %.

The composition may preferably comprise nonionic surfactant. Preferably the non-ionic surfactant is selected from saturated and mono-unsaturated aliphatic alcohol ethoxylates and saturated and mono-unsaturated fatty acid sugar esters. More preferably the non-ionic surfactant is saturated and mono-unsaturated aliphatic alcohol ethoxylates, preferably selected from C₁₂ to C₂₀ primary linear alcohol ethoxylates with an average of from 5 to 30 ethoxylates, more preferably C₁₆ to C₁₈ with an average of from 10 to 25 ethoxylates.

The formulation may comprise anionic detergent compounds which preferably are C₁₂ to C₁S alkyl ether carboxylate and water-soluble alkali metal salts of organic sulphates, ether sulphates and sulphonates having alkyl radicals containing from about 8 to about 22 carbon atoms, the term alkyl being used to include the alkyl portion of higher alkyl radicals.

Examples of suitable synthetic anionic detergent compounds are sodium and potassium alkyl sulphates, especially those obtained by sulphating higher C₁₂ to C₁₈ alcohols, sodium and potassium alkyl C₉ to C₂₀ benzene sulphonates, particularly sodium linear secondary alkyl C₁₀ to C₁₈ benzene sulphonates, alkyl (preferably methyl) ester sulphonates, and mixtures thereof.

Preferably these are present at lower levels than the glyceride carboxylate, preferably the weight fraction of further anionic surfactant/glyceride carboxylate is from 0 to 0.4, preferably 0 to 0.1

Preferably the surfactants used are saturated or mono-unsaturated.

To prevent oxidation of the formulation an anti-oxidant may be present in the formulation.

Builders or Complexing Agents

The composition may comprise a builder.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate.

Examples of calcium ion-exchange builder materials include the various types of water-insoluble crystalline or amorphous aluminosilicates, of which zeolites are well known representatives thereof, e.g. zeolite A, zeolite B (also known as zeolite P), zeolite C, zeolite X, zeolite Y and also the zeolite P-type as described in EP-A-0,384,070.

The composition may also contain 0-65 wt. % of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Zeolite and carbonate (carbonate (including bicarbonate and sesquicarbonate) are preferred builders, with carbonates being particularly preferred.

The composition may contain as builder a crystalline aluminosilicate, preferably an alkali metal aluminosilicate, more preferably a sodium aluminosilicate. This is typically present at a level of less than 15 wt. %, preferably less than 12.5 wt. %, more preferably less than 10 wt. %.

Aluminosilicates are materials having the general formula:

0.8-1.5 M₂O. Al₂O₃. 0.8-6 SiO₂

where M is a monovalent cation, preferably sodium.

These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alternatively, or additionally to the aluminosilicate builders, phosphate builders may be used. In this art the term ‘phosphate’ embraces diphosphate, triphosphate, and phosphonate species. Other forms of builder include silicates, such as soluble silicates, metasilicates, layered silicates (e.g. SKS-6 from Hoechst).

More preferably the laundry detergent formulation is a non-phosphate built laundry detergent formulation, i.e., contains less than 1 wt. % of phosphate. Most preferably the laundry detergent formulation is not built i.e. contain less than 1 wt. % of builder.

If the detergent composition is an aqueous liquid laundry detergent it is preferred that mono propylene glycol is present at a level from 1 to 30 wt. %, most preferably 2 to 18 wt. %, to provide the formulation with appropriate, pourable viscosity.

Fluorescent Agent

The composition preferably comprises a fluorescent agent (optical brightener).

Fluorescent agents are well known and many such fluorescent agents are available commercially. Usually, these fluorescent agents are supplied and used in the form of their alkali metal salts, for example, the sodium salts.

The total amount of the fluorescent agent or agents used in the composition is generally from 0.0001 to 0.5 wt. %, preferably 0.005 to 2 wt. %, more preferably 0.01 to 0.1 wt. %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are fluorescers with CAS-No 3426-43-5; CAS-No 35632-99-6; CAS-No 24565-13-7; CAS-No 12224-16-7; CAS-No 13863-31-5; CAS-No 4193-55-9; CAS-No 16090-02-1; CAS-No 133-66-4; CAS-No 68444-86-0; CAS-No 27344-41-8.

Most preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulphonate, disodium 4,4′-bis{[(4-anilino-6-morpholino-1,3,5-triazin-2-yl)]amino} stilbene-2-2′ disulphonate, and disodium 4,4′-bis(2-sulphostyryl)biphenyl.

Perfume

The composition preferably comprises a perfume. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

Preferably the perfume comprises at least one note (compound) from: alpha-isomethyl ionone, benzyl salicylate; citronellol; coumarin; hexyl cinnamal; linalool; pentanoic acid, 2-methyl-, ethyl ester; octanal; benzyl acetate; 1,6-octadien-3-ol, 3,7-dimethyl-, 3-acetate; cyclohexanol, 2-(1,1-dimethylethyl)-, 1-acetate; delta-damascone; beta-ionone; verdyl acetate; dodecanal; hexyl cinnamic aldehyde; cyclopentadecanolide; benzeneacetic acid, 2-phenylethyl ester; amyl salicylate; beta-caryophyllene; ethyl undecylenate; geranyl anthranilate; alpha-irone; beta-phenyl ethyl benzoate; alpa-santalol; cedrol; cedryl acetate; cedry formate; cyclohexyl salicyate; gamma-dodecalactone; and, beta phenylethyl phenyl acetate.

Useful components of the perfume include materials of both natural and synthetic origin. They include single compounds and mixtures. Specific examples of such components may be found in the current literature, e.g., in Fenaroli's Handbook of Flavour Ingredients, 1975, CRC Press; Synthetic Food Adjuncts, 1947 by M. B. Jacobs, edited by Van Nostrand; or Perfume and Flavour Chemicals by S. Arctander 1969, Montclair, N.J. (USA).

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt. % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

The International Fragrance Association has published a list of fragrance ingredients (perfumes) in 2011. (http://www.ifraorg.org/en-us/inaredients#.U7Z4hPldWzk) The Research Institute for Fragrance Materials provides a database of perfumes (fragrances) with safety information.

Perfume top note may be used to cue the whiteness and brightness benefit of the invention. Some or all of the perfume may be encapsulated, typical perfume components which it is advantageous to encapsulate, include those with a relatively low boiling point, preferably those with a boiling point of less than 300, preferably 100-250 Celsius. It is also advantageous to encapsulate perfume components which have a low C Log P (ie. those which will have a greater tendency to be partitioned into water), preferably with a C Log P of less than 3.0. These materials, of relatively low boiling point and relatively low C Log P have been called the “delayed blooming” perfume ingredients and include one or more of the following materials: allyl caproate, amyl acetate, amyl propionate, anisic aldehyde, anisole, benzaldehyde, benzyl acetate, benzyl acetone, benzyl alcohol, benzyl formate, benzyl iso valerate, benzyl propionate, beta gamma hexenol, camphor gum, laevo-carvone, d-carvone, cinnamic alcohol, cinamyl formate, cis-jasmone, cis-3-hexenyl acetate, cuminic alcohol, cyclal c, dimethyl benzyl carbinol, dimethyl benzyl carbinol acetate, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, flor acetate (tricyclo decenyl acetate), frutene (tricyclco decenyl propionate), geraniol, hexenol, hexenyl acetate, hexyl acetate, hexyl formate, hydratropic alcohol, hydroxycitronellal, indone, isoamyl alcohol, iso menthone, isopulegyl acetate, isoquinolone, ligustral, linalool, linalool oxide, linalyl formate, menthone, menthyl acetphenone, methyl amyl ketone, methyl anthranilate, methyl benzoate, methyl benyl acetate, methyl eugenol, methyl heptenone, methyl heptine carbonate, methyl heptyl ketone, methyl hexyl ketone, methyl phenyl carbinyl acetate, methyl salicylate, methyl-n-methyl anthranilate, nerol, octalactone, octyl alcohol, p-cresol, p-cresol methyl ether, p-methoxy acetophenone, p-methyl acetophenone, phenoxy ethanol, phenyl acetaldehyde, phenyl ethyl acetate, phenyl ethyl alcohol, phenyl ethyl dimethyl carbinol, prenyl acetate, propyl bornate, pulegone, rose oxide, safrole, 4-terpinenol, alpha-terpinenol, and/or viridine. It is commonplace for a plurality of perfume components to be present in a formulation. In the compositions of the present invention it is envisaged that there will be four or more, preferably five or more, more preferably six or more or even seven or more different perfume components from the list given of delayed blooming perfumes given above present in the perfume.

Another group of perfumes with which the present invention can be applied are the so-called ‘aromatherapy’ materials. These include many components also used in perfumery, including components of essential oils such as Clary Sage, Eucalyptus, Geranium, Lavender, Mace Extract, Neroli, Nutmeg, Spearmint, Sweet Violet Leaf and Valerian. It is preferred that the laundry treatment composition does not contain a peroxygen bleach, e.g., sodium percarbonate, sodium perborate, and peracid.

Polymers

The composition may comprise one or more further polymers. Examples are carboxymethylcellulose, poly (ethylene glycol), poly(vinyl alcohol), polycarboxylates such as polyacrylates, maleic/acrylic acid copolymers and lauryl methacrylate/acrylic acid copolymers.

Where alkyl groups are sufficiently long to form branched or cyclic chains, the alkyl groups encompass branched, cyclic and linear alkyl chains. The alkyl groups are preferably linear or branched, most preferably linear.

Enzymes, such as proteases, amylases and cellulases may be present in the formulation.

The detergent compositions optionally include one or more laundry adjunct ingredients.

The term “adjunct ingredient” includes: perfumes, dispersing agents, stabilizers, pH control agents, metal ion control agents, colorants, brighteners, dyes, odour control agent, pro-perfumes, cyclodextrin, perfume, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mould control agents, mildew control agents, antiviral agents, antimicrobials, drying agents, stain resistance agents, soil release agents, malodour control agents, fabric refreshing agents, chlorine bleach odour control agents, dye fixatives, dye transfer inhibitors, shading dyes, colour maintenance agents, colour restoration, rejuvenation agents, anti-fading agents, whiteness enhancers, anti-abrasion agents, wear resistance agents, fabric integrity agents, anti-wear agents, and rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, and combinations thereof. If present, such adjuncts can be used at a level of from 0.1% to 5% by weight of the composition

The indefinite article “a” or “an” and its corresponding definite article “the” as used herein means at least one, or one or more, unless specified otherwise.

The invention will be further described with the following non-limiting examples.

### EXAMPLES

A detergent product was created containing 5 wt. % surfactant in water at pH=7 with and without the addition of 0.01 wt. % of lipase (lipex Evity® ex Novozymes (EC 3.1.1.3))

COOP brand Lard was purchased from the COOP (UK), stored in a domestic refrigerator and used as supplied. A small portion of lard was placed in a glass test tube and the Lard melted by placing in a batch of hot water. 0.070 g of the melted lard was places in a small flat bottomed glass tube (28 ml tube) and allowed to solidify in a film on the bottom. The detergent product was added to water to give 10 ml of wash solution at pH=7, 20° F.H with 0.5 g/L surfactant and 0 or 1 mg/L lipase. The detergent solution was added to the tube and the tube sealed and placed in an incubator set to 40° C. with a shaker speed of 150 rpm for 1 hour. After wash the sample was place in ice for 30 minutes then the wash liquor was removed and the tube rinsed twice with 50 ml of cold 24° F.H water. The experiment was done in triplicate. The samples were left overnight (18 hours) then the residual lard in each tube dissolved in 5 ml of toluene and the solution used to spot onto a stainless Steel MALDI plate. For each tube 6 MALDI deposition spots were made giving a total of 18 measurements per condition. When the toluene had evaporated the MALDI Mass spectra were measured on a Bruker Autoflex using 100% laser power.

Lard hydrolysis by the lipase was measured by area of the relative area of the diglyceride peaks, DG34:1 and DG35:0, which are formed by hydrolysis of the lard triglycerdes. DGx:y refers to a diglyceride with x carbon atoms excluding the glycerol group and a total of y carbon carbon double bonds.

The RA is the relative area of each glyceride peak which is calculated as

RA=100*area of diglyceride/sum of area of triglyceride (TG48:1 to TG54:1)

The triglyceride peaks used for the sum of area of triglycerides were TG48:1, TG50:3, TG50:2, TG50:1, TG50:0, TG51:1, TG51:0, TG52:4, TG52:3, TG52:2, TG52:1, TG52:0, TG53:2, TG53:1, TG53:0, TG54:6, TG54:4, TG54:3, TG54:2, and TG54:1.

TGx:y refers to a triglyceride with x carbon atoms excluding the glycerol group and a total of y carbon carbon double bonds.

95% confidence limits were calculated from the repeats.

The results are tabulated below

DG34:1 Results Table

| Surfactant | control | 95% | with lipase | 95% |
|---|---|---|---|---|
| LES (2EO) comparative | 2.7 | 0.5 | 15.1 | 0.8 |
| SES (2EO) comparative | 2.7 | 0.4 | 8.1 | 1.0 |
| C18 Citrem inventive | 2.8 | 0.4 | 30.9 | 1.0 |
| C18 Datem inventive | 2.8 | 0.6 | 36.7 | 2.9 |

DG35:0 Results Table

| Surfactant | control | 95% | with lipase | 95% |
|---|---|---|---|---|
| LES (2EO) comparative | 4.6 | 0.9 | 4.3 | 0.5 |
| SES (2EO) comparative | 2.7 | 0.5 | 4.3 | 1.2 |
| C18 Citrem inventive | 3.1 | 0.4 | 5.8 | 1.0 |
| C18 Datem inventive | 3.2 | 0.8 | 7.0 | 1.1 |

LES(2EO) is Lauryl ether sulfate with 2 moles of ethoxylation

SES(2EO) is stearyl ether sulfate with 2 moles of ethoxylation

C18 Datem is is the diacetyl tartaric acid ester of monoiglycerides made from edible, fully hydrogenated rapeseed oil.

C18 Citrem is the citric acid ester of mono and diglycerides, made from edible, fully hydrogenated rapeseed oil.

Rapeseed oil contains greater than 90% C18 fatty acids.

The relative concentration of the diglycerides increase in the presence of the lipase, due to lipase hydrolysis of the triglyceride.

The lipase is most active in the presence of C18 Datem and C18 Citrem, the glyceride carboxylates compared to the combination of lipase with conventional (nonionic) surfactant.

1. A detergent composition, comprising:
a) from 2 to 95 wt. %, preferably from 2 to 50 wt. %, more preferably from 2 to 40 wt. %, most preferably from 2.5 wt. % to 40 wt. % of an organic acid derivative of mono- and di-glycerides of the form:— 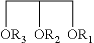
wherein one or two, of R₁, R₂ and R₃ are independently selected from an acyl group of the formula R₄CO—; where R₄ is a linear or branched, saturated or mon-unsaturated C₉ to C₂₁ alkyl chain;
wherein one or two, of R₁, R₂ and R₃ is selected from an organic acid of generic formulation (HOOC)ₙXCO—; wherein X is saturated or monounsaturated organic group containing 1 to 6 carbon atoms and n=1 to 3;
wherein one or none of R₁, R₂ and R₃ is selected from H; and,
b) from 0.0005 to 0.5 wt. %, preferably from 0.005 to 0.2 wt. % of a lipid esterase enzyme.

2. A detergent composition according to claim 1, wherein one of R₁, R₂ and R₃ are independently selected from an acyl group of the formula R₄CO— where R₄ is a linear or branched, saturated or mon-unsaturated C₉ to C₂₁ alkyl chain.

3. A detergent composition according to claim 1, wherein R₄ is a linear or branched, saturated or mon-unsaturated C₁₅ to C₂₁ linear alkyl chain, preferably a saturated or mon-unsaturated C₁₅ to C₁₇ linear alkyl chain.

4. A detergent composition according to claim 1, wherein one, of R₁, R₂ and R₃ is selected from an organic acid of generic formulation (HOOC)ₙXCO—; wherein X is saturated or monounsaturated organic group containing 1 to 6 carbon atoms and n=1 to 3

5. A detergent composition according to claim 1, wherein (HOOC)ₙXCO is selected from citric acid, malic acid, tartaric acid, monoacetyl and diacetyl tartaric acid, succinic acid, oxalic acid, maleic acid, fumaric acid, malonic acid, more preferably citric acid, lactic acid, tartaric acid, monoacetyl and diacetyl tartaric acid, where an OH is lost from an acid group to form the ester.

6. A detergent composition according to claim 1, wherein one of R₁, R₂ and R₃ is selected from H.

7. A detergent composition according to claim 1, wherein the organic acid derivative of mono- and di-glycerides are selected from:—citric acid esters of mono- and diglycerides (citrem); tartaric acid esters of mono- and di-glycerides (tatem); diacetyltartaric acid esters of mono- and diglycerides (datem); and, mixed acetic-, tartaric- and di-acetylated tartaric acid esters of mono- and di-glycerides (MATEM);
preferably the organic acid derivative of mono- and di-glycerides are selected from:—
citric acid esters of mono- and diglycerides (citrem); tartaric acid esters of mono- and di-glycerides (tatem); and, diacetyltartaric acid esters of mono- and diglycerides (datem); most preferably the organic acid derivative of mono- and di-glycerides are selected from:—citric acid esters of mono- and diglycerides (citrem).

8. A detergent composition according to claim 1, wherein the detergent composition is a laundry detergent composition.

9. A detergent composition according to claim 8, comprising an nonionic surfactant selected from saturated and mono-unsaturated aliphatic alcohol ethoxylates and saturated and mono-unsaturated fatty acid sugar esters; preferably the non-ionic surfactant is saturated and mono-unsaturated aliphatic alcohol ethoxylates, preferably selected from C₁₂ to C₂₀ primary linear alcohol ethoxylates with an average of from 5 to 30 ethoxylates, more preferably C₁₆ to C₁₈ with an average of from 10 to 25 ethoxylates.

10. A laundry detergent composition according to claim 8, comprising an anionic surfactant selected from C₁₂ to C₁₈ alkyl ether carboxylate and water-soluble alkali metal salts of organic sulphates, ether sulphates and sulphonates having alkyl radicals containing from 8 to 22 carbon atoms.

11. A laundry detergent composition according to claim 1 wherein the lipid esterase is selected from triacylglycerol lipases (E.C. 3.1.1.3); carboxylic ester hydrolase (E.C. 3.1.1.1); Cutinase (E.C. 3.1.1.74); sterol esterase (E.C. 3.1.1.13); wax-ester hydrolase (E.C. 3.1.1.50), preferably a triacylglycerol lipases (E.C. 3.1.1.3).

12. A laundry detergent composition according to claim 8, comprising one or more enzymes from the group: proteases, amylases and cellulases.

13. A laundry detergent composition according to claim 8, wherein the composition is a liquid or a liquid unit dose composition.

14. A domestic method of treating a textile, comprising the steps of:—
a) treating a textile with an aqueous solution of 0.5 to 20 g/L, more preferably 1 to 10 g/L of the detergent composition according to any one of claims 1 to 13;
b) optionally rinsing and drying the textile.
